(19) United States
(12) Patent Application Publication
(10) Pub. No.: US 2003/0231755 A1
(43) Pub. Date: Dec. 18, 2003

(54) Directory assistance

(76) Inventors: Akhteruzzaman, Naperville, IL (US); Paul Raymond Sand, Woodridge, IL (US); Richard Grant Sparber, Wheaton, IL (US); Claudis L. Young, Aurora, IL (US)

Correspondence Address: Werner Ulrich, 434 Maple Street, Glen Ellyn, IL, 60137, US

(21) Appl. No.: 10/174,419

(22) Filed: Jun. 18, 2002

(51) Int. Cl. H04M 3/42

(52) U.S. Cl. 379/218.01; 379/207.12

(57) ABSTRACT

A method and apparatus for obtaining Directory Assistance, and/or driving directions based on a limited geographical area defined by the present location of a wireless user, or a wire-line user, or a location specified by either of these users. A section of a location oriented database associated with that location is searched for names or categories of customers meeting the criteria offered by the caller. If an appropriate destination can be found, a telephone number is supplied and a connection is established, or driving directions are provided for going from the present location of the caller to the destination location. Advantageously, driving directions may be obtained even when the called party's name is very common, and the caller does not know the address, even if the caller is in an unfamiliar area.

### TECHNICAL FIELD

This invention relates to Directory Assistance and customer location systems.

### PROBLEM

Directory Assistance systems are normally segmented by the geographical location of the party whose telephone number is being sought. When a Directory Assistance call is made, the first question that is asked is: “What City Please?” The basic objective is to find a telephone number for the purpose of establishing a telephone connection.

However, there are situations in which the location of a caller is an important input to a Directory Assistance system, and further, the value of a Directory Assistance system can be substantially enhanced if the system also provides information on how to drive to the desired party. An example of this kind of use is when a mobile roamer wants to locate a telephone user, but the roamer is not sure of his/her own location, or that the city is so large that help is needed to find the location of a desired telephone customer. This need is not served by any presently existing system.

### SOLUTION

Applicants have analyzed this problem and have concluded that what is needed is a system having a database in which the geographic segments are much smaller than a city, so that someone with a very common name, like “Smith”, can be found in a much smaller segment, and wherein this smaller segment is defined by the caller's present location. Accordingly, the system proposed by the inventors, is a system which represents an advance over the prior art and is one wherein a mobile user is first located geographically, and then the called party is located with the help of a focused Directory Assist-ance database segment centered upon the present location of a caller or a location specified by that caller; the system also locates the caller if necessary, and either simply establishes a connection to the called party, or provides instructions on how to get to the called party. (The latter is especially helpful if the called party is not at home, or is otherwise, not answering the tele-phone.) In accordance with one preferred embodiment, a mobile station is located either by means of Global Positioning System (GPS) mounted with the mobile station, and arrangements whereby the mobile station reports its location to a mobile switch for forwarding to the database or the mobile station, is located in accordance with standard arrangements, from cell sites of a mobile system, and this location is passed on to the directory assistance system. That system then interacts with the mobile user providing names and telephone numbers to allow the destination to be identified and arrang-ing to either connect the mobile station to the destination user or to provide instructions on how to drive from the present location of the mobile station to the user's location. The directory assistance system interacts with a data-base arranged to use the caller's location to help find data for the called party.

In accordance with a feature of Applicants' invention, the directory assistance system can also be accessed from a land-based station so that a user at that station can get the same driving directions as a mobile station. The location of the land based station is provided, for example, by an E911 database, which stores the geographic location at all land base stations. This can be particularly useful for a caller calling from a location far from home.

### BRIEF DESCRIPTION OF THE DRAWING(S)

FIG. 1 is a block diagram showing the apparatus of Applicants' invention;

FIG. 2 is a layout of data in the database of FIG. 1; and

FIGS. 3 and 4 are flow diagrams illustrating the operation of Applicants' invention from a mobile user and a land based user, respectively.

### DETAILED DESCRIPTION

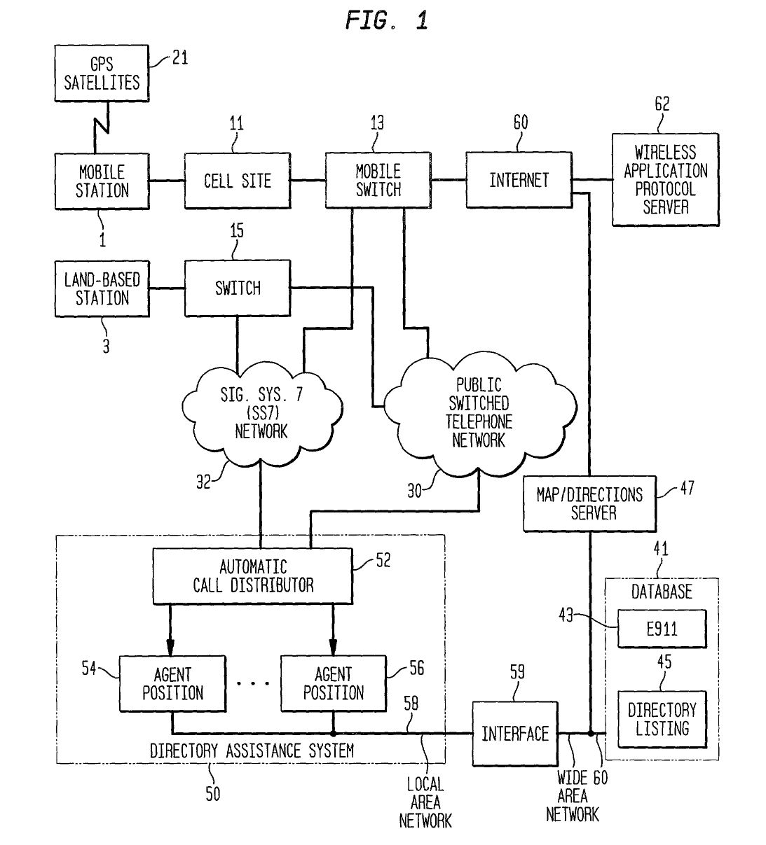

FIG. 1 is a block diagram illustrating the interconnection of the major blocks representing elements of the apparatus required to practice Appli-cants' invention. A user at a mobile station (1) needs to obtain a telephone number and/or destination customer location information of a type that is not provided by conventional directory assistance systems. For example, the mobile station may be a roamer in a large distant city, and may believe that he/she is close to the destination user who has a very common name. A conventional directory assistance system and its database would not be able to identify such user, but the database (41) of this invention is arranged to be able to search over users within a relatively small radius of an initial location. The mobile station's location can be derived accurately if the mobile station (1) is equipped with a Global Positioning System (GPS) device, in which case the mobile station can transmit its location toward the database via serving cell site (11) and mobile switch (13). If the mobile station is not equipped with a GPS device, then the cell site (11) and other cell sites near mobile station (1), together can locate the mobile station within 100 meters (⅔ of the time), or 300 meters (95% of the time), using, for example, the techniques that are described in a TIA Industry Standard for Meeting the Requirements of the FCCJ-STD-036, a requirement imposed on mobile systems that are to meet the requirements of E911, Phase II in the United States. The approximate, or more exact location, is then forwarded to the directory assistance system (40) and database (41), which offers to the caller the names and telephone num-bers of one or more users within an appropriate radius of the location of the caller. As with conventional directory assistance, the caller interfaces with an operator at directory assistance center (50) to determine appropriate spelling and other information necessary to select the correct destination telephone user. Alternatively, the mobile station may specify a different spotting point for the search if the mobile station believes that the destination user is close to some other point at a different location than the caller. The mobile station accesses the database via a conventional directory assistance system (50). This system is connected to the Public Switched Telephone Network (PSTN) (30) and a Signaling System 7 (SS7) Signaling Network (32). These two networks are connected to an automatic call distributor (52) within the directory assistance system. The automatic call distributor distributes calls among agent positions (54), . . . , (56). Each agent position is attended by either an operator or an automated operation, which can perform many of the functions of an operator. The agent positions receive the position data from the mobile switch (13) via signaling system (32) and the automatic call distributor (52), and communicate with the caller via the Public Switched Telephone Network (30). The agent positions communicate with a shared database (41) via a local area network (58), an interface (59), and a wire area network (60). (The wide area network allows the database to be shared among a plurality of directory assistance systems.) The wide area network also permits the agent positions to access a mobile application program/directions server (47) for generating directions for the caller to find the called party.

The database (41) includes an E911, (an enhanced 911 emergency database). This database identifies the location of all land-based stations served by the E911 database. In addition, the database includes a directory listing (45) for finding telephone numbers corresponding to names and addresses supplied by the caller. This directory listing is further enhanced to include focused sections so that if a caller wishes to find a telephone number or an address of someone with a very common name, if the caller also supplies a location indicator, the number of possible directory listings that correspond to the caller's information and that location indicator is correspondingly reduced. Once the directory listing has been found, and the address identified, the E911 database can identify the exact location of the called party, and this location can be used as an input to a mobile application protocol (MAP)/directions server to provide directions for the caller at the mobile station to drive to the called party's location.

In addition, the mobile station can access a wireless application protocol server (62) via the Internet (60) in order to pass driving directions obtained from MAP/Directions Server (47) to the mobile station.

Thus, in accordance with this invention, the caller can either get a telephone number to contact in order to get directions; alternatively, if the call is not answered or if a connection is not requested, the directory assistance system working with the database can provide navigational information, such as driving directions for getting to the destination. There are many software packages available to provide such driving directions, given the location of a source and a destination. For example, Yahoo! MAPS provides this service over the Internet. Service may also be provided to help users at land-based locations, either at home, hotel/motel, or at a coin station, to obtain such directions. The land-based station (3) is connected via switch (15) to directory assistance system (50). The directory assistance system (50) obtains the location of the land-based station from the originating telephone number, forwarded by automatic number identification, using the E911 database (43), which stores the location of all land-based telephones. The land-based station (3) is then provided with the same type of information that is provided to mobile station (1) for a similar request.

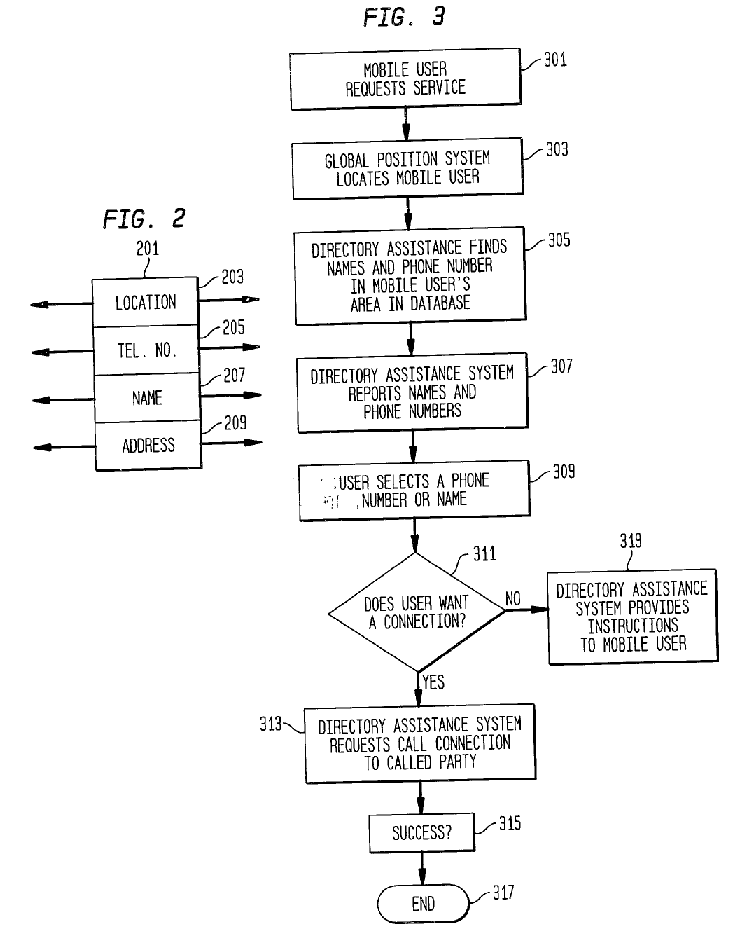

FIG. 2 shows data stored in the directory listing part (45) of database (41) for each telephone. A block of data (201) provides information on the location (203) of the telephone. Telephone number (205), the name of the user of the telephone (207) and the address of that telephone (209). The database is arranged so that it can be searched over a range of nearby locations. This is done today in searching, for example, for nearby businesses of a particular type, (e.g., pizza parlors) using the Yahoo! Yellow Pages Application.

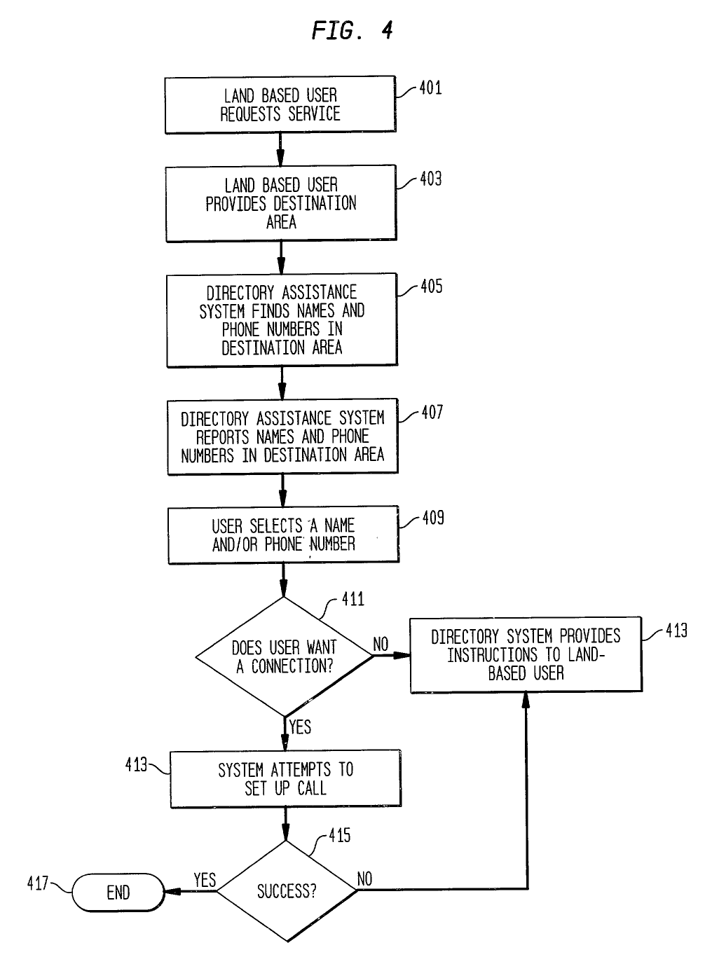

FIG. 3 is flow diagram illustrating actions performed for a mobile user of this system. The mobile user requests service, such as obtaining the phone number of the destination, Action Block (301). The location system, (e.g., GPS), locates the physical location of the mobile user, Action Block (303). The directory assistance system finds related names and phone numbers in the area of the mobile user, Action Block (305). The directory assistance system reports names and phone numbers to the user, Action Block (307). The user selects a particular name or a telephone number, Action Block (309). Test (311) is used to determine whether the user wants a connection or direct driving instructions. If the user wants a connection, then the directory assistance system requests a call connection, Action Block (313). Test (315) is used to determine whether the call was successfully set up. If so, then this is the end of the series of actions. If not, then the directory assistance system provides the user with instructions on how to drive to the destination, Action Block (319). If the result of Test (311) is that the user does not want a connection, then the directory assistance system provides the instructions to the mobile user, Action Block (319).

FIG. 4 shows actions performed in serving a land-based user. A land-based user requests the location service, Action Block (401). The land-based user provides destination area location data to the system, Action Block (403). The system finds names and telephone numbers in the destination area, Action Block (405). The system reports names and telephone numbers to the user, Action Block (407). The user then selects a telephone number, Action Block (409). Test (411) is used to determine whether the user wants a connection or instructions. If the user wants a connection, the system attempts to set-up a call, Action Block (413). Test (415) is used to determine whether the attempt was successful. If so, this is the end of the series of actions, Action Block (417). If the attempt to setup the connection was not successful, then Action Block (421) is entered to allow the system to provide driving instructions to the caller. Similarly, if the caller does not want a telephone connection, but wants driving instructions, the system will then provide the driving instructions, Action Block (421).

The database can also search for a category of destination stations, such as the telephone numbers, addresses, and names of hardware stores in an area. Effectively, the name field can be expanded to include a category field for specialized searches.

In an alternate embodiment of Applicants' invention, an Internet Server (62) is used instead of the directory assistance system (50) that is part of a telephone wireless network. Using the Internet (60), a wireless unit can access using a wireless application protocol server (62), and a land-based user can access the Internet in the conventional way. The Internet can use Browser techniques to search the database.

The above preferred embodiment is one embodiment of Applicants' invention. Other embodiments will be apparent to those of ordinary skill in the art. The invention is only limited by the attached claims.

We claim:

1. A method of providing driving instructions to a telecommunications user, comprising the steps of:
providing a location identifier to a database for storing location information;
searching said database for an identity of a telephone customer within a specified radius of said identified location consistent with the caller's identification of a called party;
providing said calling party with navigational informat-ion for arriving at the location of said called party.

2. The method of claim 1, wherein said calling party is calling from a mobile telephone station.

3. The method of claim 2, wherein the specified location is the location of said calling party.

4. The method of claim 1, wherein said calling party is calling from a land based telephone station, and the location of said calling party is part of the data retained by a serving common carrier for said telephone station.

5. The method of claim 1 further comprising the steps of
offering to set up a connection to said called party; and
in response to a positive response, attempting to establish a connection to said called party.

6. The method of claim 2, wherein a location of said calling party is provided by a Global Positioning System (GPS) device associated with a calling party.

7. The method of claim 2, wherein the position of said calling party is found using techniques used by E911 systems to locate a mobile caller.
